(19) United States
(12) Patent Application Publication
(10) Pub. No.: US 2025/0368127 A1
(43) Pub. Date: Dec. 4, 2025

(54) VEHICLE LIGHTING SYSTEM AND METHOD WITH DISPLAY INTERACTION INFORMATION, AND VEHICLE THEREOF

(71) Applicant: AutoX, Inc., Grand Cayman (KY)

(72) Inventors: Jianxiong Xiao, Shenzhen (CN); Zhuo Li, Shenzhen (CN); Zhenyu Li, Shenzhen (CN); Wen Xiao, Shenzhen (CN)

(73) Assignee: AutoX, Inc., Grand Cayman (KY)

(21) Appl. No.: 19/226,463

(22) Filed: Jun. 3, 2025

(30) Foreign Application Priority Data
Jun. 4, 2024 (CN) 2024107183219

(51) Int. Cl. B60Q 1/50; B60W 60/00

(52) U.S. Cl. CPC B60Q 1/5037; B60Q 1/507; B60W 60/001; B60W 2554/4029; B60W 2756/00

(57) ABSTRACT

The disclosure provides a vehicle lighting system with display interaction information, including a vehicle lamp, a display, and a control device. The vehicle lamp includes a housing and a light source within the housing for emits light, the vehicle lamp is arranged according to vehicle regulations; the display is within the housing. The control device includes one or more processor configured to: acquire a decision of a currently executed operation of the vehicle and perception information; determine whether to illuminate the display or not based on the decision of the currently executed operation of the vehicle; determine content to be displayed based on the perception information, and control the display to display the content; the content displayed on the display being selected from a plurality of predetermined contents to demonstrate the decision of the currently executed operation of the vehicle for interaction with an external object.

### CROSS REFERENCE TO RELATED APPLICATION

This non-provisional patent application claims priority under 35 U. S. C. § 119 from Chinese Patent Application No. 202410718321.9 filed on Jun. 4, 2024, the entire content of which is incorporated herein by reference.

### TECHNICAL FIELD

The disclosure relates to the field of vehicle lighting technology, particularly to a vehicle lighting system with display interaction information and an autonomous incorporating the same.

### BACKGROUND

With the development of computer technology and artificial intelligence, vehicle technology has achieved significant progress. Existing vehicle lamps generally serve illumination and warning functions. For example, brake lights are illuminated when the vehicle brakes; turn signals are illuminated when the vehicle turns; and fog lights are illuminated in foggy conditions. However, external objects, such as pedestrians or drivers or passengers of other vehicles, can only better notice the vehicle and the operation it is currently performing through the vehicle lamps. However, external objects usually cannot understand the current decision of the vehicle through the vehicle lamps. Especially when multiple trigger operation buttons are shared by the current vehicle. For example, when the brake lights are illuminated, external objects cannot determine whether the vehicle is braking due to a traffic light or a pedestrian, or whether it is braking or decelerating. Another example is when the vehicle's steering components and vehicle imaging system share the same controls. When the turn signal is illuminated, external objects cannot judge whether the vehicle is changing lanes or triggering the imaging system. As a result, external objects often cannot make accurate decisions, causing confusion during traffic flow. In other words, the interaction between existing vehicle lamps and external objects is poor, leading to inconvenience in traffic flow.

### SUMMARY

In view of this, the disclosure provides a vehicle lighting system with display interaction information and a vehicle incorporating the same, which can better interact with external objects.

In a first aspect, the disclosure provides a vehicle lighting system with display interaction information. The vehicle lighting system with display interaction information for a vehicle, wherein the vehicle lighting system comprises: a vehicle lamp, comprising a housing and a light source disposed within the housing, the light source being configured to emit light, the vehicle lamp being arranged according to vehicle regulations, the vehicle regulations including a position of the vehicle lamp and lighting effects of the vehicle lamp; a display, being disposed within the housing; and a control device, including one or more processor configured to: acquire a decision of a currently executed operation of the vehicle and perception information; determine whether to illuminate the display or not based on the decision of the currently executed operation of the vehicle; determine content to be displayed based on the perception information, and control the display to display the content; the content displayed on the display being selected from a plurality of predetermined contents to demonstrate the decision of the currently executed operation of the vehicle for interaction with an external object.

In a second aspect, the disclosure provides a vehicle lighting method for display interaction information for a vehicle. The vehicle lighting method for display interaction information for a vehicle, the vehicle lamp including a housing and a light source disposed within the housing, the light source being configured to emit light, the vehicle lamp being arranged according to vehicle regulations, the vehicle regulations including a position of the vehicle lamp and lighting effects of the vehicle lamp; wherein the vehicle lighting method for display interaction information includes: acquiring a decision of a currently executed operation of the vehicle and perception information; determining whether to illuminate the display or not based on the decision of the currently executed operation of the vehicle; determining content to be displayed based on the perception information, and controlling the display to display the content; the content displayed on the display being selected from a plurality of predetermined contents to demonstrate the decision of the currently executed operation of the vehicle for interaction with an external object.

In a third aspect, the disclosure provides a vehicle. The vehicle has a plurality of vehicle lamps, each vehicle lamp includes a housing and a light source disposed within the housing, the light source being configured to emit light, the vehicle lamps being arranged according to vehicle regulations. The vehicle regulations includes positions of the vehicle lamps and the lighting effects of the vehicle lamps, wherein the vehicle includes a plurality of displays and a control device, the displays are disposed within the housing. The control device is configured to: acquire a decision of a currently executed operation of the vehicle and perception information; determine whether to illuminate the display or not based on the decision of the currently executed operation of the vehicle; determine content to be displayed based on the perception information, and control the display to display the content; the content displayed on the display being selected from a plurality of predetermined contents to demonstrate the decision of the currently executed operation of the vehicle for interaction with an external object.

In the aforementioned vehicle lighting system with display interaction information and the vehicle incorporating the same, the display is disposed within the housing of the vehicle lamp. On one hand, the display is integrated with the vehicle lamp, enabling the vehicle to display rich interaction information through both the display and the vehicle lamp. On the other hand, this arrangement makes the display less prone to wear, increasing its service life. The control device includes an analysis unit and a display control unit. The analysis unit is configured to acquire a decision of a currently executed operation of a vehicle and perception information, determine whether to illuminate the display based on the decision of the currently executed operation of the vehicle, and determine content to be displayed based on the perception information. The vehicle executes a corresponding operation according to the decision. The display control unit is configured to control the display to display the content. The content displayed on the display is selected from a plurality of predetermined contents to demonstrate the decision of the currently executed operation of the vehicle for interaction with an external object.

### BRIEF DESCRIPTION OF THE DRAWINGS

To more clearly illustrate the technical solutions in the embodiments of the disclosure or in the prior art, the drawings required for the description of the embodiments or the prior art will be briefly introduced below. It is obvious that the drawings in the following description are only some embodiments of the disclosure. For those of ordinary skill in the art, other drawings can be obtained based on these drawings without creative efforts.

FIG. 1 is a schematic structural diagram of a vehicle lighting system with display interaction information applied to a vehicle provided in this embodiment.

FIG. 2 is a schematic diagram of a scene where a vehicle stops at a red light provided in this embodiment.

FIG. 3 is a partially enlarged schematic diagram of the vehicle lighting system when the vehicle stops at a red light provided in this embodiment.

FIG. 4 is a schematic diagram of a scene where a vehicle yields to a pedestrian provided in this embodiment.

FIG. 5 is a partially enlarged schematic diagram of the vehicle lighting system when the vehicle yields to a pedestrian provided in this embodiment.

FIG. 6 is a connection diagram of the vehicle lighting system and a main control device provided in this embodiment.

### COMPONENT SYMBOL DESCRIPTION

1. vehicle lighting system; 11. Vehicle lamp; 111. Housing; 112. Light source; 12. display; 13. Control device; 131. Analysis unit; 132. Display control unit; 2. Main control device; 21. Decision module; 22. Perception module; 100. Vehicle.

The objectives, functional characteristics, and advantages of the disclosure will be further explained in conjunction with the embodiments and with reference to the accompanying drawings.

### DETAILED DESCRIPTION OF THE EMBODIMENTS

To make the objectives, technical solutions, and advantages of the disclosure clearer, the disclosure will be further elaborated in detail below in conjunction with the accompanying drawings and embodiments. It should be understood that the specific embodiments described herein are merely for illustrating the disclosure and are not intended to limit the disclosure. Based on the embodiments of the disclosure, all other embodiments obtained by those of ordinary skill in the art without creative efforts shall fall within the protection scope of the disclosure.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is understood that the descriptions involving “first,” “second,” etc., in the present application are solely for descriptive purpose and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

The disclosure provides a vehicle lighting system with display interaction information. The vehicle lighting system can be applied to both autonomous vehicles and manually driven vehicles, providing rich interaction information for external objects to understand the current driving state of the vehicle, thereby achieving interaction with external objects. External objects include pedestrians or vehicles around the vehicle. Below, the vehicle lighting system with display interaction information applied to a vehicle is used as an example for illustration.

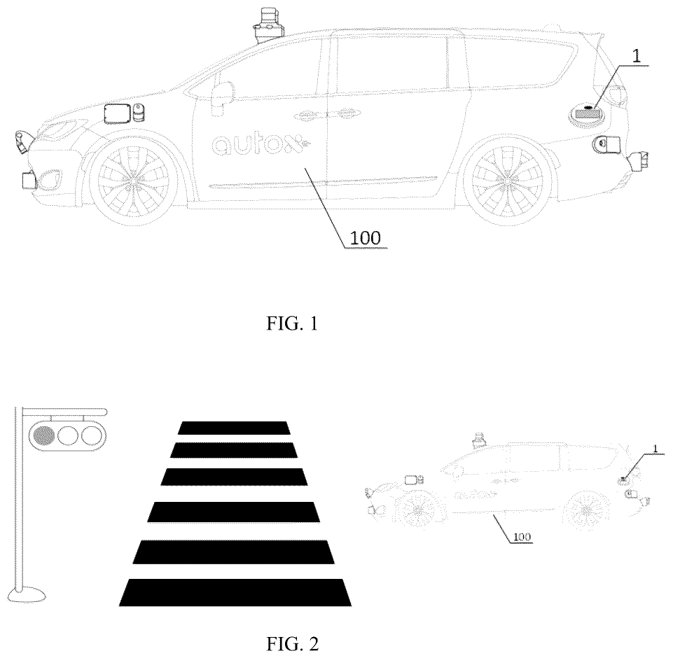

FIG. 1 is a schematic structural diagram of a vehicle lighting system with display interaction information applied to a vehicle provided in this embodiment. The vehicle lighting system 1 is applied in a vehicle 100 to indicate or convey to external objects a reason for the vehicle 100 executed current operation of the vehicle 100. The vehicle lighting system 1 with display interaction information provided in the disclosure includes a vehicle lamp 11, a display 12, and a control device 13. The display 12 is integrated with the vehicle lamp 11. The control device 13 can be integrated with the vehicle lamp 11 or disposed outside the vehicle lamp 11 to control the display 12. The control device 13 is implemented as either a dedicated chip module or a Printed Circuit Board (PCB) designed to support specific functions, depending on the vehicle system requirements.

The vehicle lamp 11 includes a housing 111 and a light source 112 disposed within the housing 111. The light source 112 is configured to emit light. The vehicle lamp 11 and lighting effects are arranged according to vehicle regulations, which refer to automotive standards that comply with national legislation on automotive standards, with variations among different countries. The vehicle regulations in this embodiment mainly refer to the standards for vehicle lamps 11 in the vehicle regulations, including position s of the vehicle lamps 11 and the lighting effects of the vehicle lamps 11. That is, the positions and lighting effects of the vehicle lamps 11 in this embodiment are set according to regulations. In this embodiment, the vehicle lamp 11 can be a turn signal, a position lamp, a brake light, etc. In the standards for vehicle lamps 11, the types of vehicle lamps 11 are determined by the position and lighting effects. Different types of vehicle lamps 11 perform different functions. For example, turn signals are disposed at the front and rear of the vehicle 100 in a rectangular distribution. When not turning, the turn signals are off. When turning, the turn signals are illuminated and flashing, with orange light. The housing 111 is transparent to facilitate light transmission.

The display 12 is disposed within the housing 111, thereby integrating the light source 112 and the display 12 in the vehicle lamp 11. The display 12 is an LED display. In one embodiment, the display 12 is provided with a plurality of light strips (not shown), which are arranged according to predetermined contents. Alternatively, the display 12 displays content according to preset image information. In this embodiment, the vehicle 100 is an autonomous vehicle. The content displayed on the display 12 is used to convey to external objects a decision of the currently executed operation of the vehicle 100. For example, the vehicle has been turned off, the vehicle is braking, the vehicle has entered autonomous driving mode, there is a pedestrian in front of the vehicle, etc. The external objects can be pedestrians or drivers or passengers on other vehicles, enabling external objects to know the true situation of the current vehicle 100 and make more accurate decisions. Usually, when the vehicle lamp 11 is in operation, external objects can only speculate on the action being performed by the vehicle 100 based on the current state of the vehicle lamp 11. For example, when the brake light is on, external objects can only know that the vehicle 100 is braking but do not know whether it is emergency braking or decelerating, nor do they know the reason for the emergency braking or decelerating decision made by the vehicle 100. The vehicle lighting system 1 provided in this embodiment can display the decision of the currently executed operation of the vehicle 100 through the display 12, thereby assisting external objects in more quickly and accurately understanding the decision of the vehicle 100 and facilitating the decision-making of external objects. For example, pedestrians can know whether they can walk around the front of the vehicle 100, and nearby vehicles can decide whether to yield or proceed, making traffic flow more convenient for external objects.

Whether the display 12 is illuminated or the content displayed is controlled by the control device 13. The control device 13 is configured to control the display 12 to display corresponding information. In this embodiment, the information displayed on the display 12 can be text content, patterns, or a combination of both. Text content includes words, letters, numbers, symbols, etc. Specifically, the control device 13 can be a control chip or a control circuit board. The control device 13 is programmed with software to control the operation of the vehicle lighting system 1.

The control device 13 is configured to communicate with the main control device 2 of the vehicle. The control device 13 obtains the decision of the currently executed operation of the vehicle 100 and perception information based on data generated by the main control device 2.

In this embodiment, the control device 13 includes an analysis unit 131 and a display control unit 132. The analysis unit 131 and the display control unit 132 are program blocks in the control device 13 that perform specific functions.

The analysis unit 131 is configured to acquire the decision of the currently executed operation of the vehicle 100 and perception information and determine whether to illuminate the display 12 based on the decision of the currently executed operation of the vehicle 100 and determine the content to be displayed based on the perception information. The decision of the currently executed operation of the vehicle 100 and the perception information are obtained by the control device 13 from the main control device 2. The main control device 2 is responsible for controlling the operation of various functional components in the vehicle 100. It can be understood that the vehicle lighting system 1 is also controlled by the main control device 2.

The display control unit 132 is configured to control the display 12 to display the content determined by the analysis unit 131 based on the perception information. The content displayed on the display 12 is selected from a plurality of predetermined contents to demonstrate the decision of the currently executed operation of the vehicle 100 for interaction with an external object.

In some feasible embodiments, the display 12 can dynamically display information corresponding to predetermined contents. Furthermore, the predetermined contents should correspond one-to-one with the expressed interaction information. That is, one preset content cannot correspond to multiple interaction information, and one interaction information cannot correspond to multiple predetermined contents. This prevents confusion in the recognition of interaction information by external objects.

Multiple illuminated displays 12 can display different contents or the same content at the same time. Specifically, the content displayed on the display 12 is determined by the control device 13. When the control device 13 determines that a single preset content is to be displayed, multiple displays 12 display information corresponding to the same preset content at the same time. When the control device 13 determines that multiple predetermined contents are to be displayed, multiple displays 12 respectively display information corresponding to the multiple predetermined contents at the same time, that is, the multiple displays 12 display different contents.

Referring to FIG. 6, the main control device 2 includes a decision module 21 and a perception module 22. The decision module 21 is in communication with the perception module 22. The perception module 22 is configured to generate perception information. The decision module 21 is configured to make a decision based on the perception information to control the vehicle 100 to enter the currently executed operation. The perception module 22 perceives based on sensor data from sensors (not shown) disposed on the vehicle 100 or external data from external devices to obtain perception information, such as whether there are obstacles around the vehicle 100, the speed and distance of the obstacles, and the width and curvature of the road. Furthermore, the perception module 22 uses data fusion technology to fuse the sensor data and external data to obtain the final perception information. The sensors collect scene information data around the vehicle 100. The sensor data includes radar sensor data, camera sensor data, positioning system sensing data, etc. The external data includes data uploaded by other vehicles 100 and data provided by third-party platforms, such as weather data, traffic condition data, etc.

The decision module 21 controls the behavior of the vehicle 100 to drive, such as accelerating, decelerating, turning left, turning right, and regulating the vehicle lighting system 1, etc., which are the output decisions of the decision module 21. The decision module 21 constructs scenes at different levels based on the perception information, calculates individual decisions for each scene in combination with traffic regulations, checks for conflicting individual decisions, resolves conflicts among individual decisions based on their priorities, and obtains a final decision after comprehensive consideration of all individual decisions. Furthermore, individual decisions have priorities. When there are multiple individual decisions with conflicts among them, the decision module 21 selects the individual decision with the highest priority as the final decision. When there are multiple individual decisions without conflicts among them, the decision module 21 fuses the multiple individual decisions into the final decision. The control device 13 of the vehicle lighting system 1 receives the decision sent by the decision module 21. In this embodiment, when there are multiple individual decisions related to the vehicle lighting system 1 with conflicts among them, the decision module 21 selects the individual decision with the highest priority as the final decision.

The decision module 21 outputs the final decision to the corresponding lower-level modules together, that is, for regulating the vehicle lighting system 1. On one hand, it controls the behavior of the vehicle 100. On the other hand, it controls the vehicle lighting system 1 to illuminate the corresponding light source or display 12 and display the corresponding interaction information.

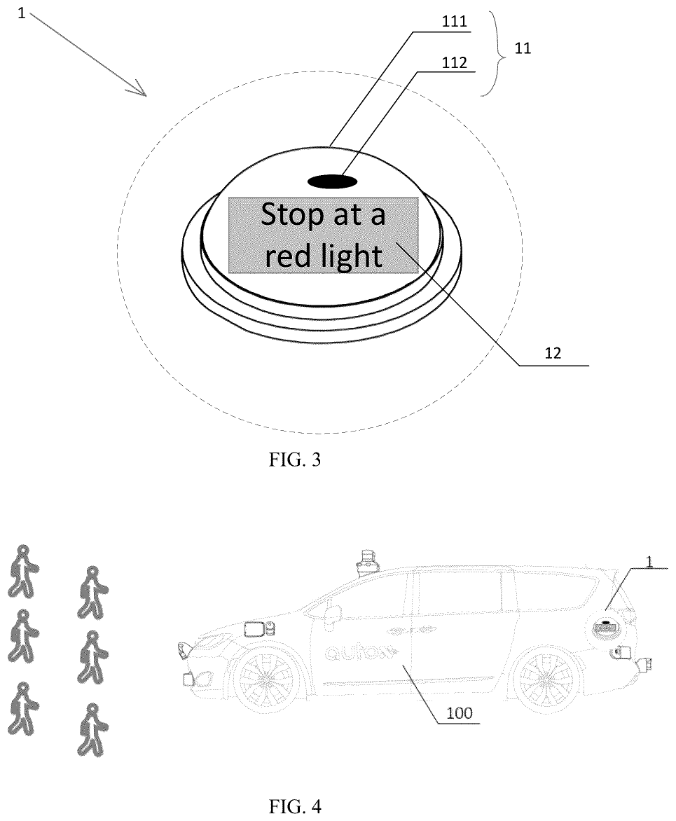

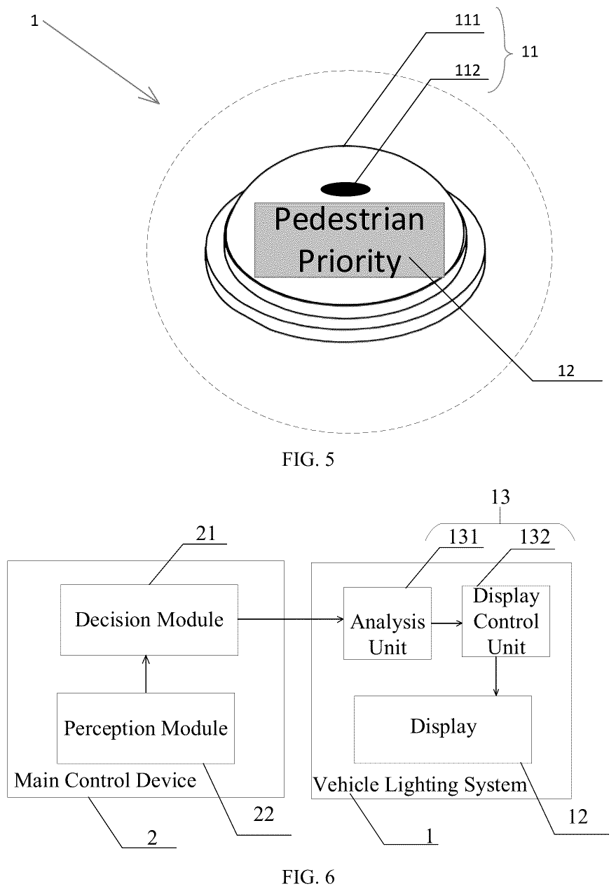

Referring to FIGS. 2-5, specific examples of the vehicle lighting system 1 displaying interaction information in different scenarios are shown. It can be understood that whether the display 12 is illuminated and the content displayed are respectively determined by the currently executed operation of the vehicle 100 and the perception information. As shown in FIGS. 2 and 3, when the perception module 22 perceives that the traffic light in front of the vehicle 100 is red, the decision module 21 issues a decision to stop to control the vehicle 100 to stop. The analysis unit 131 illuminates the display 12 based on the decision to stop and selects words or patterns indicating that the vehicle 100 is stopping at a red light, such as the words: “Red light, stop.” The display control unit 132 controls the display 12 to display the corresponding content. As shown in FIGS. 4 and 5, when the perception module 22 perceives that there is a pedestrian passing in front of the vehicle 100, the decision module 21 issues a decision to stop to control the vehicle 100 to stop. The analysis unit 131 determines to illuminate the display 12 based on the decision to stop and selects words or patterns indicating that the vehicle 100 is stopping to yield to a pedestrian, such as the words: “Pedestrian Priority” The display control unit 132 controls the display 13 to display the corresponding content.

Referring to FIG. 1 again, the disclosure also provides a vehicle 100. The vehicle 100 is provided with a vehicle lighting system 1 with display interaction information. The vehicle lighting system 1 includes a plurality of vehicle lamps 11, displays 12 disposed within the housings 111 of the plurality of vehicle lamps 11, and a control device 13 for controlling whether the displays 12 operate and determining the content displayed on the displays 12. For the specific structure of the vehicle lighting system 1, please refer to the above description, which will not be repeated here.

In this embodiment, a display 12 is added to the vehicle 100. The display 12 displays rich information for interaction with external objects during driving. Specifically, first, the display 12 is disposed within the housing 111. On one hand, the display 12 is integrated with the vehicle lamp 11, enabling the vehicle 100 to display rich interaction information through both the display 12 and the vehicle lamp 11. On the other hand, this arrangement makes the display 12 less prone to wear, increasing its service life. Second, the analysis unit 131 is configured to acquire the decision of the currently executed operation of the vehicle 100 and perception information and determine whether to illuminate the display 12 based on the decision of the currently executed operation of the vehicle 100 and determine the content to be displayed based on the perception information. The vehicle 100 executes a corresponding operation according to the decision. Third, the display control unit 132 is configured to control the display 12 to display the content determined by the analysis unit 131 based on the perception information. The content displayed on the display 12 is selected from a plurality of predetermined contents to demonstrate the decision of the currently executed operation of the vehicle 100 for interaction with an external object.

Obviously, those skilled in the art can make various modifications and variations to the disclosure without departing from the spirit and scope of the disclosure. In this case, if such modifications and variations of the disclosure fall within the scope of the claims and their equivalents, the disclosure is also intended to include these modifications and variations.

The above-listed are merely preferred embodiments of the disclosure and are not intended to limit the protection scope of the disclosure. Therefore, equivalent changes made according to the claims of the disclosure still fall within the scope covered by the disclosure.

1. A vehicle lighting system with display interaction information for a vehicle, wherein the vehicle lighting system comprises:
a vehicle lamp, comprising a housing and a light source disposed within the housing, the light source being configured to emit light, the vehicle lamp being arranged according to vehicle regulations, the vehicle regulations including a position of the vehicle lamp and lighting effects of the vehicle lamp;
a display, being disposed within the housing; and
a control device, including one or more processor configured to:
acquire a decision of a currently executed operation of the vehicle and perception information;
determine whether to illuminate the display or not based on the decision of the currently executed operation of the vehicle;
determine content to be displayed based on the perception information, and
control the display to display the content; the content displayed on the display being selected from a plurality of predetermined contents to demonstrate the decision of the currently executed operation of the vehicle for interaction with an external object.

2. The vehicle lighting system with display interaction information according to claim 1, wherein the display is an LED display, the display includes a plurality of light strips, the light strips are arranged according to predetermined contents, the control device is configured to control the plurality of light strips to display information corresponding to the predetermined contents.

3. The vehicle lighting system with display interaction information according to claim 1, wherein the control device converts predetermined contents into display signals, the display displaying information corresponding to the predetermined contents according to the display signals.

4. The vehicle lighting system with display interaction information according to claim 3, wherein the control device is configured to communicate with a main control device of the vehicle, the control device obtains a reason for the vehicle entering the current driving state based on data generated by the main control device.

5. The vehicle lighting system with display interaction information according to claim 3, wherein the main control device is configured to: generate perception information; make the decision based on the perception information to control the vehicle to enter the currently executed operation; the perception information indicates the reason for the vehicle entering the current driving state.

6. A vehicle lighting method for display interaction information for a vehicle, the vehicle lamp including a housing and a light source disposed within the housing, the light source being configured to emit light, the vehicle lamp being arranged according to vehicle regulations, the vehicle regulations including a position of the vehicle lamp and lighting effects of the vehicle lamp; wherein the vehicle lighting method for display interaction information comprises:
acquiring a decision of a currently executed operation of the vehicle and perception information;
determining whether to illuminate the display or not based on the decision of the currently executed operation of the vehicle;
determining content to be displayed based on the perception information, and
controlling the display to display the content; the content displayed on the display being selected from a plurality of predetermined contents to demonstrate the decision of the currently executed operation of the vehicle for interaction with an external object.

7. The vehicle lighting method for display interaction information according to claim 6, wherein the display is an LED display, the display includes a plurality of light strips, the light strips are arranged according to predetermined contents, the control device is configured to control the plurality of light strips to display information corresponding to the predetermined contents.

8. The vehicle lighting method for display interaction information according to claim 6, wherein controlling the display to display the content includes converting predetermined contents into display signals, the display displaying information corresponding to the predetermined contents according to the display signals.

9. The vehicle lighting method for display interaction information according to claim 8, further comprising: obtaining a reason for the vehicle entering the current driving state based on data generated by a main control device of the vehicle.

10. The vehicle lighting method for display interaction information according to claim 8, wherein the main control device is configured to: generate perception information; make the decision based on the perception information to control the vehicle to enter the currently executed operation; the perception information indicates the reason for the vehicle entering the current driving state.

11. A vehicle, having a plurality of vehicle lamps, each vehicle lamp comprising a housing and a light source disposed within the housing, the light source being configured to emit light, the vehicle lamps being arranged according to vehicle regulations, the vehicle regulations including positions of the vehicle lamps and the lighting effects of the vehicle lamps, wherein the vehicle comprises a plurality of displays and a control device, the displays being disposed within the housing; the control device being configured to:
acquire a decision of a currently executed operation of the vehicle and perception information;
determine whether to illuminate the display or not based on the decision of the currently executed operation of the vehicle;
determine content to be displayed based on the perception information, and
control the display to display the content; the content displayed on the display being selected from a plurality of predetermined contents to demonstrate the decision of the currently executed operation of the vehicle for interaction with an external object.

12. The vehicle according to claim 11, wherein the control device is further configured to convert predetermined contents into display signals, the display displaying information corresponding to the predetermined contents according to the display signals.

13. The vehicle according to claim 12, wherein the control device is further configured to communicate with a main control device of the vehicle, the control device obtains a reason for the vehicle entering the current driving state based on data generated by the main control device.

14. The vehicle according to claim 12, wherein the main control device comprises a decision module and a perception module, the perception module being configured to generate perception information; the decision module being configured to make a decision based on the perception information to control the vehicle to enter the currently executed operation; the perception information indicating the vehicle entering the current driving state.

15. The vehicle according to claim 11, wherein some of the displays display different contents at the same time.
